(19) United States
(12) Patent Application Publication
(10) Pub. No.: US 2013/0212388 A1
(43) Pub. Date: Aug. 15, 2013

(54) PROVIDING TRUSTWORTHY WORKFLOW ACROSS TRUST BOUNDARIES

(71) Applicants: Roy Peter D'Souza, Bellevue, WA (US); Jieming Zhu, Saratoga, CA (US)

(72) Inventors: Roy Peter D'Souza, Bellevue, WA (US); Jieming Zhu, Saratoga, CA (US)

(73) Assignee: ALEPHCLOUD SYSTEMS, INC., Saratoga, CA (US)

(21) Appl. No.: 13/613,080

(22) Filed: Sep. 13, 2012

Related U.S. Application Data
(60) Provisional application No. 61/598,071, filed on Feb. 13, 2012.

(51) Int. Cl. H04L 9/32

(52) U.S. Cl. 713/168

(57) ABSTRACT

Methods, systems and apparatuses for providing trustworthy workflow across trust boundaries are disclosed. One method includes a curator generating a first public key (PK_{C1}) and a second public key (PK_{C2}), publishing the first public key (PK_{C1}) and the second public key (PK_{C2}), and generating a first proxy re-encryption key (RK_{C1-C2}) and a second proxy re-encryption key (RK_{C2-B}). Further, a first party encrypts data having a key k, wherein k is encrypted according to the first public key (PK_{C1}). A custodian proxy re-encrypts k from the first public key (PK_{C1}) to the second public key (PK_{C2}) using the first proxy re-encryption key (RK _{C1-C2}), and the custodian proxy re-encrypts k from the second public key (PK_{C2}) to a public key (PK_{B}) of the second party B using the second proxy re-encryption key (RK_{C2-B}). The second party B receiving the data and decrypting the data with the key k.

### RELATED APPLICATIONS

This application is related to U.S. Provisional Patent Application No. 61/598,071, filed Feb. 13, 2012, and entitled “High-Scale and Distributed Business and Consumer Networks,” which is hereby incorporated herein by reference.

### FIELD OF THE DESCRIBED EMBODIMENTS

The described embodiments relate generally to electronic communication through cloud networks. More particularly, the described embodiments relate to methods, systems and apparatuses for providing trustworthy workflow across trust boundaries of cloud networks.

### BACKGROUND

A trust boundary in an electronic network is defined as a region within which all computer systems, their operations, and the data are trusted. Typically, a trust boundary is protected by computer security hardware and software such as firewalls, Virtual Private Networks (VPNs), intrusion detection and prevention systems, data leakage protections, antivirus programs, etc. For example, for an organization, a trust boundary may include an entire data center infrastructure, including computers connected via VPNs. For an individual, a laptop computer could be her trust boundary.

Various mechanisms exist today to facilitate secure communications between trust boundaries. SSL/TLS and IPSec are two examples. These mechanisms are intrinsically point-to-point, thus for many-to-many secure information sharing and collaboration, it will require a worst case “N-squared messy cross-bar” connectivity for all N trust boundaries where every party needs to be able to field electronic communications from every other party. This can become costly and complex.

On the other hand, Web based technologies, and now cloud computing make information sharing and collaboration increasingly cheaper and easier. In essence, this is a central intermediary based hub-spoke communication model. When it comes to secure sharing, this model requires that the central intermediary to be a trusted escrow that must be trusted by all parties across all trust boundaries in the network and that no one in the network will surreptitiously game the system for their own profit.

Such a blind trust hub-spoke model tends to fail due to a range of challenges that include breaches of hub's electronic perimeters, insider attacks, coercion from governments and organized crimes, and other threats to the hub. All indications are that any model that involves conventional electronic security, and is based on a need to trust any central individual or organization to follow the rules, is deeply flawed. This is demonstrated by the fact that even with improvements in technologies for monitoring and protection, the rate of successful intrusions and internal malfeasance is actually rising rapidly.

In present day enterprises, the custodian (typically the hub, the infrastructure service operator/provider in physical possession of the sensitive data)and the curator (typically some spoke, the IT organization that owes and authorizes access to this data) are within the same organization, and most likely within the same legal and compliance domain. Authentication is typically implemented through techniques such as Kerberos; authorization is typically through infrastructure such as AD and Security Groups; access control is enforced by the various data containers that include databases, document management systems, and networked file systems. Organizations also leverage PKI and X.509v3 for identity through Smart Cards, SAML for single sign-on and authorization. Various technologies exist for the organization to implement its own Authentication and Authorization, and to federate beyond that organization with business partners and other service providers or service consumers.

When IT infrastructures such as data storage or containers are moved to a hosting service in the cloud, the role of the custodian and curator is separated, where the cloud service provider that is hosting the data is now the custodian of that data, while the curatorship continues to remain in the hands of functionaries within that organization. For legal, compliance and other business IP protection reasons, organizations can't afford the blind trust on the cloud service providers, thus are disinclined to adopt these services, or they demand unlimited liability protection.

In order to solve this problem, the cloud needs to be constrained in function to be only a policy enforcement service that is implementing the exact policy specified by the customer organization and its curator functionary. Furthermore, this new cloud architecture needs to seamlessly integrate, without any significant requirement to modify the existing IT infrastructure, or the existing business process.

In short, there is no solution existing today that can allow organizations (curators) to extend the existing IT infrastructures along with the business processes (such as Governance, Risk Management, and Compliance, GRC in short) to the cloud service providers (custodians), across the trust boundaries while a) the data privacy and confidentiality are ensured—custodians can never see the data nor the policies about how the data can be accessed; b) the visibility and the control of the data are filly retained by the curators; and c) multiple curators across trust boundaries can collaborate and share the sensitive data through the custodians.

There is a need for systems, methods and apparatuses that address the above-listed requirements in cloud computing, and provide a trustworthy workflow across trust boundaries between parties.

A trustworthy workflow is defined as a cryptography based mechanism that enables all parties to securely communicate across trust boundaries through the central intermediary (the hub), without the hub ever being able to access the data, nor the data access policies. All end-points in such a workflow can count on the same degree of trustworthiness of a point-to-point secure communications supported by protocols such as SSL/TSL and IPSec, as described before,

### SUMMARY

An embodiment includes a method of providing trustworthy workflow across trust boundaries between a first party A and a second party B. The method includes one or more curators generating a first public key (PK_{C1}) and a second public key (PK_{C2}), the one or more curators publishing the first public key (PK_{C1}) and the second public key (PK _{C2}), the one or more curators generating a first proxy re-encryption key (RK_{C1-C2}) and a second proxy re-encryption key (RK_{C2-B}). The method further includes the first party A encrypting data having a key k, wherein k is encrypted according to the first public key (PK_{C1}). The one or more custodians proxy re-encrypt k from the first public key (PK_{C1}) to the second public key (PK_{C2}) using the first proxy re-encryption key (RK_{C1-C2}), wherein the proxy re-encryption is one-way, and the one or more custodians proxy re-encrypt k from the second public key (PK_{C2}) to a public key (PK_{B}) of the second party B using the second proxy re-encryption key (RK_{C2-B}), wherein the proxy re-encryption is one-way. The second party B receives the data and decrypts the data with the key k, decrypted from a secret key SK_{B}.

Another embodiment includes a system for providing trustworthy workflow across trust boundaries between a first party A and a second party B. The system includes one or more curator servers operative to generate a first public key (PK_{C1}) and a, second public key (PK_{C2}), publish the first public key (PK_{C1}) and the second public key (PK_{C2}), and generate a first proxy re-encryption key (RK_{C1-C2}) and a second proxy re-encryption key (RK_{C2-B}). The first party server A is operative to encrypt data having a key k, wherein k is encrypted according to the first public key (PK_{C1}). One or more custodian servers are operative to proxy re-encrypt k from the first public key (PK_{C1}) to the second public key (PK_{C2}) using the first proxy re-encryption key (RK_{C1-C2}), wherein the proxy re-encryption is one-way, and proxy re-encrypt k from the second public key (PK_{C2}) to a public key (PK_{B}) of the second party B using the second proxy re-encryption key (RK_{C2-B}), wherein the proxy re-encryption is one-way. The second party server B is operative to receive the data and decrypting the data with the key k, decrypted from a secret key SK_{B}.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system that provides trustworthy workflow between a first party A and a second party B, according to an embodiment.

FIG. 2 shows another system that provides trustworthy workflow between a first party A and a second party B, according to an embodiment.

FIG. 3 shows a system that provides trustworthy workflow of log data from a first party A and a regulator, according to an embodiment.

FIG. 4 is a flow chart that includes steps of a method of providing trustworthy workflow across trust boundaries between a first party A and a second party B.

FIG. 5 shows a client connect agent according to an embodiment

FIG. 6 shows a service connect agent according to an embodiment.

FIG. 7 shows a cloud connect service according to an embodiment.

FIG. 8 shows an example of a mesh-like architecture that connects nodes.

FIG. 9 shows an example of a mesh-like architecture wherein nodes include users.

FIG. 10 shows an example of a mesh-like architecture that includes a hub that enables and supports many networks.

FIG. 11 shows an example of a mesh-like architecture that includes a hosting party (supervisor) that set rules and supervises the networks.

FIG. 12 shows an example of a mesh-like architecture that includes a service provider that is delivering a service such as collaboration or commerce, and a variety of participants that are consuming that service.

FIG. 13 shows an example of a mesh-like architecture hat includes a service provider that straddling multiple sovereign boundaries.

FIG. 14 shows an example of a mesh-like architecture that includes a service that fragment along sovereign, legal or compliance boundaries, and federates with other providers.

FIG. 15 shows atypical syndication scheme where a service provider “B” is re-using and enhancing or extending a service from provider “A” in some manner before delivering it to its customers.

FIG. 16 shows an example how a service delivered to a network of participants could itself be composed by a network of service providers, which are supervised by a collection of mutually distrustful sovereign, legal and/or regulatory entities.

FIG. 17 shows an example of a mesh-like architecture that includes multiple service providers, wherein each service provider is typically compelled to implement “back doors” and to provide key escrowing capabilities.

FIG. 18 shows an example how two guardians can collaborate such that they implement mechanisms such as data leakage prevention on outbound data, and data provenance establishment on inbound data.

FIG. 19 shows an example that includes two lower participants (or service providers) that are consuming a service provided by a higher service provider.

### DETAILED DESCRIPTION

The described embodiments include methods, systems and apparatuses for providing trushworthy workflow across trust boundaries of cloud networks. Further, the described embodiments a trustworthy workflow that includes multiple hops, is non-interactive, one-way, collusion-resistant, and delegation-resistant.

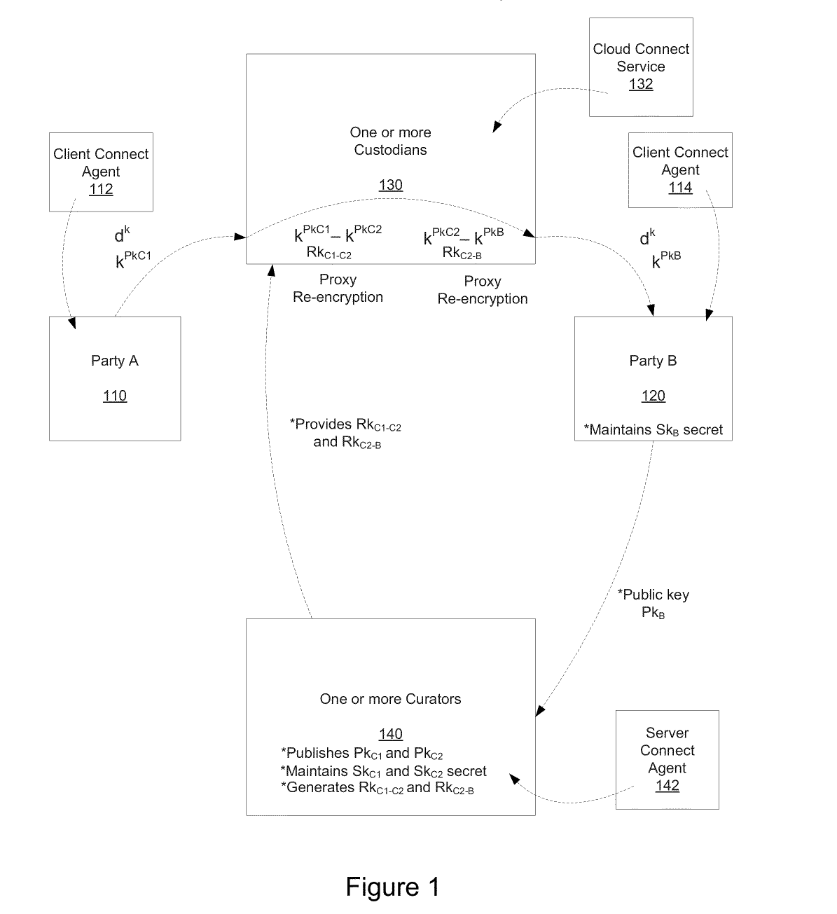

FIG. 1 shows a system that provides trustworthy workflow between a first party A and a second party B, according to an embodiment. As shown, this embodiment includes one or more custodians 130, and one or more curators 140 that provide trustworthy workflow between the first party A and the second party B. Each of the one or more custodians 130, the one or more curators 140, the first party A, and the second party B include one or more servers, wherein each server includes at least one or more processors and memory.

As shown, for at least one embodiment, the one or more custodians 130 have access to a cloud connect service (CCS) 132, one or more curators 140 have access to a service connect agent (SCA) 142, and the first party A and the second party B have access to client connect agents (CCA) 112, 114,

For at least some embodiments, a curator includes organizations or individuals who are the owners of information and its associated management/access policies. As shown, the one or more curators 140 generating a first public key (PK_{C1}) and a second public key (PK_{C2}), which are then published. The first public key (PK_{C1}) and the second public key (PK_{C2}) have a corresponding secret first secret key (SK_{C1}) and a second secret key (SK_{C2}) which the one or more curators maintain as a secret.

The one or more curators 140 also generate a first proxy re-encryption key (RK_{C1-C2}) and a second proxy re-encryption key (RK_{C2-B}). While this embodiment includes two proxy re-encryption keys, it is to be understood that other embodiments include any possible number of proxy re-encryption keys. For at least some embodiments of this example, the one or more curators 140 generate the second proxy re-encryption key (RK_{C2-B}) based on a public key Pk_{B} obtained from the one or more custodians. That is, the one or more curators 140 generate the second proxy re-encryption key (RK_{C2-B}) without knowledge of the secret key SK_{B} of the second party B.

For one embodiment, the first proxy re-encryption key (RK_{C1-C2}) and the second proxy re-encryption key (RK_{C2-B}) are both generated by a single curator. Further, the corresponding secret first secret key (SK_{C2}) and a second secret key (SK_{C2}) can be generated by the single curator. For another embodiment, the first proxy re-encryption key (RK_{C1-C2}) is generated by a first curator, and the second proxy re-encryption key (RK_{C2-B}) is generated by a second curator. Further, the corresponding first secret key (SK_{C1}) can be generated by the first curator, and a second secret key (SK_{C2}) can be generated by the second curator. The multiple (multiple hop) proxy re-encryption of the described embodiments is advantageous because it provides for the federation of enforcement of policies across trust boundaries.

The first party A encrypts data d, using a block cipher key k (denoted as d^{k} in the Figures), then encrypts k using the first public key, PK_{C1} (denoted as k^{PkC1} in FIGS. 1, 2 and 3), that is to eventually be received by the second party B.

The one or more custodians 130 receive the encrypted data from the first party A, as well as the encrypted k. For at least some embodiments, a custodian includes cloud service providers.

The one or more custodians 130 then perform a two-hop (as previously described, any number of hops can be utilized) proxy re-encryption process. Additionally, the proxy re-encryption of each hop is one-way. That is, custodians 130 that have an RK_{C1-C2} that atomically re-encrypts from PK_{C1} to PK_{C2} must not have the reverse permission of re-encrypting from PK_{C2}to PK_{C1}, since this violates the privacy of the owner of PK_{C1}.

More specifically, the one or more custodians 130 proxy re-encrypt k from the first public key (PK_{C1}) to the second public key (PK_{C2}) using the first proxy re-encryption key (RK_{C1-C2}), wherein the first proxy re-encryption is one-way, and then, the one or more custodians proxy re-encrypt k from the second public key (PK_{C2}) to a public key (PK_{B}) of the second party B using the second proxy re-encryption key (RK_{C2-B}), wherein the second proxy re-encryption is one-way. Therefore, k is re-encrypted to B's public key (PK_{B}) denoted as k^{PkB} in FIGS. 1, 2, and 3, without k ever being decrypted in between the steps in which the data passes through one or more custodians 130.

A valuable feature of the proxy re-encryption system and method is that the one or more custodians 130 are never able to decrypt k, nor the data d. Additionally, because the one or more curators 140 do not have the secret key SK_{B} of the second party B, the one or more curators 140 are not able to obtain the block cipher key k to decrypt the data. Additionally, the one or more custodian 130 in conjunction with the one or more curators 140 are not able to decrypt the data d. Further, if party B were to collude with any of the custodians, they would not be able to recover party A's secret key SK_{A} or any curator's secret key.

For an embodiment, the one or more curators 140 includes a plurality of curators, acting as one or more Policy Administration Points (PAP) and one or more Policy Decision Points (PDP) for one or more enterprises across trust boundaries. Further, the plurality of curators prevent the one or more custodians 130, acting as one or more Policy Enforcement Points (PEP), from accessing or tampering content of policies of the plurality of curators white enforcing the policies across the plurality of curators. For at least some embodiments, the policy enforcement actions performed by one or more custodians 130 are non-repudiable and tamper proof. At least some embodiments include the plurality of curators translating the policies into the generation of the first public key (PK_{C1}), the second public key (PK_{C2}), the first secret key (SK_{C1}), the second secret key (SK_{C2}). For at least some embodiments, there can be multiple public keys PKs and secret key SKs for each policy, and not every policy needs a proxy re-encryption key RK.

For at least some embodiment, publishing the first public key (PK_{C1}) and the second public key (PK_{C2}) includes the plurality of curators sending the first public key (PK_{C1}) and the second public key (PK_{C2}) to the one or more custodians. Further, at least some embodiments include the plurality of curators requesting for policy enforcement comprising publishing the first proxy re-encryption key (RK_{c1-c2}) and the second proxy re-encryption key (RK_{c2-B}) to one or more custodians, and sending requests to perform one or more proxy re-encryption operations to the one or more custodians. Further, at least some embodiments include the one or more custodians enforcing the policies by performing the proxy re-encrypting of k from the first public key (PK_{C1}) to the second public key (PK_{C2}) and proxy re-encrypting k from the second public key (PK_{C2}) to a public key (PK_{B}).

The second party B receives the encrypted data, and is able to obtain the block cipher key k, using the second party B's secret key Sk_{B}, and thus decrypt the data d.

As shown, the first party A has access to a client connect agent (CCA) 112, and the second party B has access to a client connect agent (CCA) 114. An embodiment of CCA can be an independent software application program running in party A or B's computing device, such as desktop, laptop, mobile device, etc. Another embodiment of CCA is operable to run within a web browser.

The described embodiment provide systems, methods and apparatuses that address the twin requirements of (a) limiting cloud service providers' power to becoming just a full-fidelity policy enforcement point in the cloud, with plausible deniability of any policy or data access, and (b) designing its integration points with any organization and its business partners in a manner that enables low-impact integration and re-use of infrastructure, process, training, and personnel within the organization and its business partners.

In one embodiment, if the enterprise is leveraging PKI and X.509v3 certificates, the CCS can integrate with OCSP (Online Certificate Status Protocol) or it can obtain and parse CRLs (Certificate Revocation Lists) so that it comes to know when users are revoked, or have compromised their credentials, and it can immediately act by refusing to perform a proxy re-encryption operation. Therefore this trustworthy workflow is not just efficient, but also more secure because revocations can be near instantaneous. Furthermore, since all documents are only accessed after a proxy re-encryption is performed, the CCS can also serve as a fine-grain audit point that can generate logs of document access and enable the owning organization to have visibility into how documents are being shared, or modified and forwarded. Finally, the CCS is a higher-scale and federated (hence inter-operable) component of a Rights Management Solution, with the enhancement of being a complete lifecycle management solution that can manage end-to-end document retention, disposition, and hold across trust boundaries, whereas existing Rights Management solutions have stilted policies that are typically limited within one domain and do not scale. Because of this combination of visibility (through audit logs) and control (through end-to-end lifecycle management) the CCS is an enabler of organization GRC that includes Legal (monitoring, supervision, surveillance, litigation support) and Compliance (Confidentiality, Availability, Integrity, and other requirements.)

To implement the policy enforcement mechanism in the cloud through the CCS, the described embodiments include a primitive called a ‘Mediation Rule’, which is an atomic policy statement. It is implemented using a cryptographic technique called Proxy Re-Encryption, where the Mediation Rule is manifested as a Proxy Re-Encryption Key.

For at least some embodiments, any policy that includes Identity, Authorization, and Access Control, can be expressed in the form of Mediation Rule primitives, similar to a compilation target in a programming language. These Mediation Rules are created by off-cloud curators, or are automatically generated by adapters within the local organizational SCA, based on policies that are stored in IT infrastructures such as AD, ADFS or LDAP. The CCS has the restricted ability to only act upon a policy that is embodied through a Mediation Rule.

An example of a Mediation Rule for Authorization is a Proxy Re-encryption key from a group to an individual of that group, which can be referred to as Claims Groups, since they mirror Identity and Authorization Claims. The Claims Group demarcates the set of users that have the authorization to perform some operation (typically Create, Read, Update or Delete) on a set of objects that are delegated to that group. All these objects are encrypted to the public key of that group, and users are authorized to be part of that group through the presence of a Mediation Rule (a Proxy Re-Encryption key in the embodiments described) that will be in the possession of the CCS, so that it can enforce that policy to provide any user with access to those Objects. For at least some embodiments, the CCS can only apply the Mediation Rule; it cannot create new Mediation Rules, and it cannot ignore or refuse to apply Mediation Rules without detection.

An example of a Mediation Rule for Access Control is a group that is used to stage documents that have a specific classification. For example “This HBI Group holds all documents that have High Business Impact”. The associated Mediation Rule is a Proxy Re-encryption Key that translates any document that is encrypted to the public key of this group (that is termed a “Demand Group”) to some claims group, such as Auditors. Suppose Bob is a member of the Auditors group, and Alice publishes a document to the HBI Group, an administrator would have generated a REK (Proxy Re-Encryption Key) from the HBI Group to the Auditors Group. Separately, that administrator (or possibly a different administrator) would have generated a REK from the Auditors Group to Bob's Public Key. If multiple administrators are involved, they can belong to one curator or multiple curators as described in at least some embodiments.

There are several significant advantages to this approach that include the fact that there is no group secret to cache and re-use, hence other than the group owner, no one else in the trustworthy workflow can define or control the policy of the group. Another benefit is that the REK is a business record that can be archived in a tamper proof manner using other cryptographic and other techniques so that it is easy to determine the existence of anypolicy (or the absence thereof) at any time, in order to support GRC requirements such as discovery.

For at least some embodiments, there can even be Mediation Rules for Identity, where an enhanced Identity Provider STS (Security Token Services)is able to authenticate a user only if it has a REK for that user. This illustrates how a single, atomic Mediation Rule can serve as a “compilation target” for complex enterprise Identity, Authorization, Access Control, and other policies. XACML is a blueprint and language for federation of policy, and in this blueprint the CCS is a Policy Enforcement Point (PEP) while the Policy Decision Points and Policy Authoring Points remain unchanged and within the trust boundaries of the respective organizations. The pivotal difference is that the PEPs of the described embodiments that are implemented through Mediation Rules cannot violate the Mediation Rules that are provided to them.

White some of the described embodiments may confine their exposition to typical enterprise policies that include identity, Authorization and Access Enforcement, the Mediation Rule primitive is even more expressive and is able to provide the CCS with additional functionalities that might include contract mediation, fair exchange, and international trade. Since a Mediation Rule cannot provide the CCS with direct access to data, and since the CCS can be designed to record these Mediation Rules in a repository in a tamper resistant manner, these Mediation Rules are business records that can provide proof of the existence of a policy at a particular time. While there have been technologies that may have been amenable to constructing Mediation Rules in the literature in the last few years, there has been a lack of technologies that can facilitate non-interactive, one-way, collusion-resistant, delegation-resistant and multi-hop Mediation. Without one, or more of these features, this primitive would be unable to represent organizational policy with full fidelity, and any solution that is not complete (in that there is some room for human error or misbehavior) then that would risk the viability and headroom for that solution.

As shown, the trustworthy workflow is the new model of enabling security through carefully designed and implemented cryptography, federated key lifecycle management, federated policy, and federated reputation networks through cloud such that sensitive information (such as data, keys, and policies) is only accessible within a trust boundary while the encrypted data and keys can be stored by the custodians and the policies associated data management and access can be enforced by the custodians, across trust boundaries. The custodians are cryptographically prevented from accessing the data, the keys and the policies, and from releasing them to unauthorized entities.

Other Trustworthy Workflows

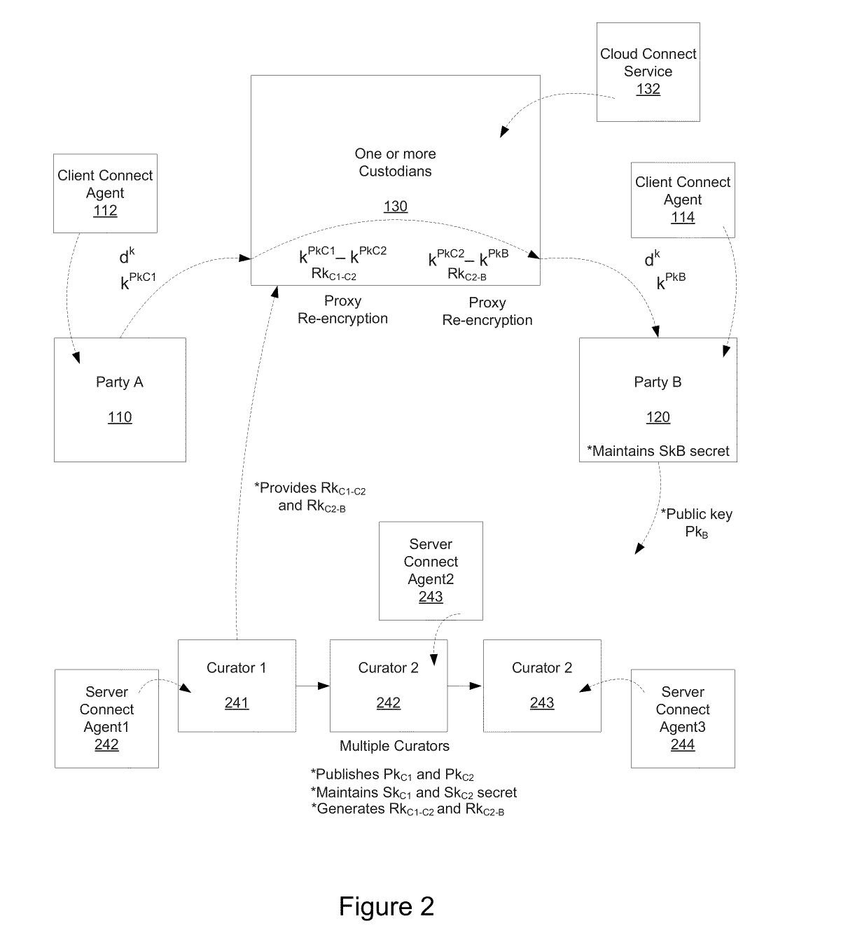

FIG. 2 shows another system that provides trustworthy workflows between a first party A and a second party B, according to an embodiment. FIG. 2 includes a plurality of curators 241, 242, 243. Each of the curators 241, 242, 243 has access to a SCA 242, 243, 244.

Multiple curators are sometimes necessarily for managing hierarchical organizations. For example, in a typical organization, there may be a top-level ‘Company Full-time Employees’ group, then a ‘US Head Office’ nested group, and in turn an ‘Engineering’ nested group. Within the Engineering group there could be some user named ‘Joe’. The translation from any parent group to contained group (one curator to another) is a hop, and the translation from the lowest contained group to the user, Joe, is the final hop (from Curator 3 243 to party B). Hence it can be quite useful to support multiple hops.

In yet another use case of multiple curators, party A could be a white-collar employee, AKA IW (or “Information Worker”) in some organization. She has an organizational relationship with a Curator 1 that represents the authority within their own organization that is involved with classifying and safeguarding their own documents. Party B might be another IW within that same organization. It might also be an IW in a different organization, which has its own curator (‘Curator 3’). Now Curator 3 is responsible for managing the organizational hierarchy (the groups, nesting of groups, memberships within groups, etc. whereas Curator 1 is responsible for managing and classifying documents. Hence Curator 1 is in the world of what is referred to as “Demand Groups” (a Demand is the inverse of a Claim, and conveys what the requirements are for getting access to a document within that kind of group). Multi-hop Proxy Re-encryption across multiple curators become necessary to enforce policies across organization or trust boundaries.

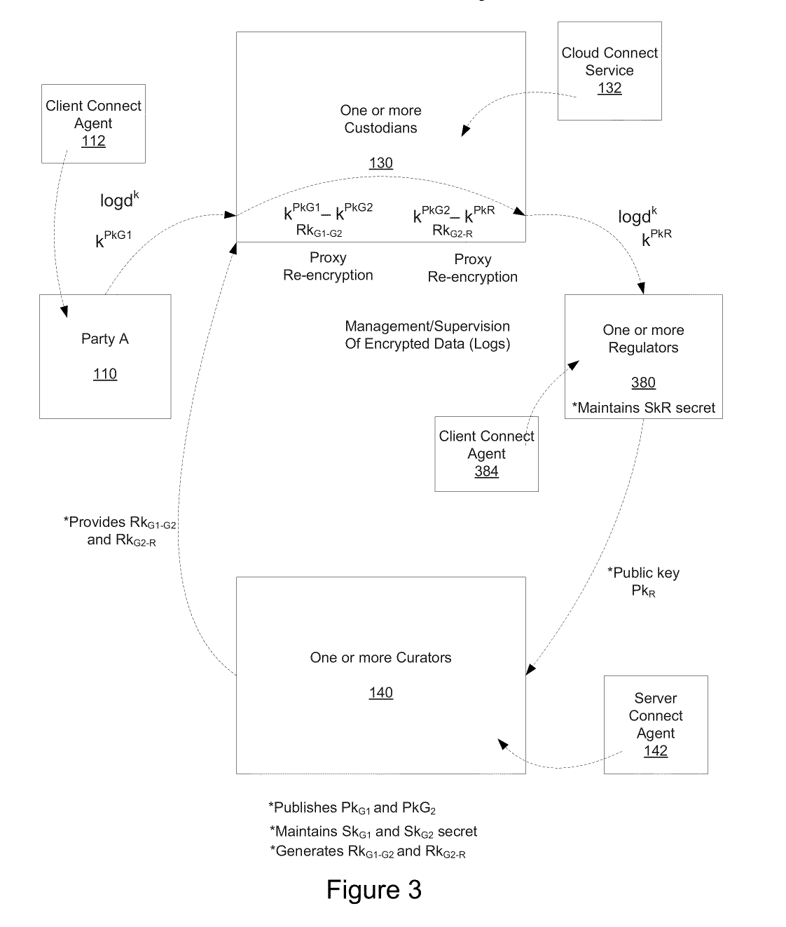

FIG. 3 shows a system that provides trustworthy workflow of log data from a first party A and a regulator, according to an embodiment. While maintaining secure communication between the first party A and the second party B, at least some embodiments include one or more regulators (such as, regulator 380) being able to monitor and supervising the activities of the first party A and the second party B. Accordingly, this embodiment includes log data (logd) being communicated from, for example, the first party A to the regulator 380. As shown, the tog data is encrypted to the key k (where k is, for example, a block cypher key), and k is encrypted to P_{kG1}. The regulator 380 has access to a client connect agent 384.

Generally, for an embodiment, the log data includes a listing of activities of an associated party or a curator and a description of data sent or received by the associated party or a curator. This embodiment is similar to the described embodiments. However, the date that is initially encrypted is “tog data” rather than “data”, and the regulator replaces the role of the second party B. The embodiment allows the regulator to regulate or monitor the log data of the first party A.

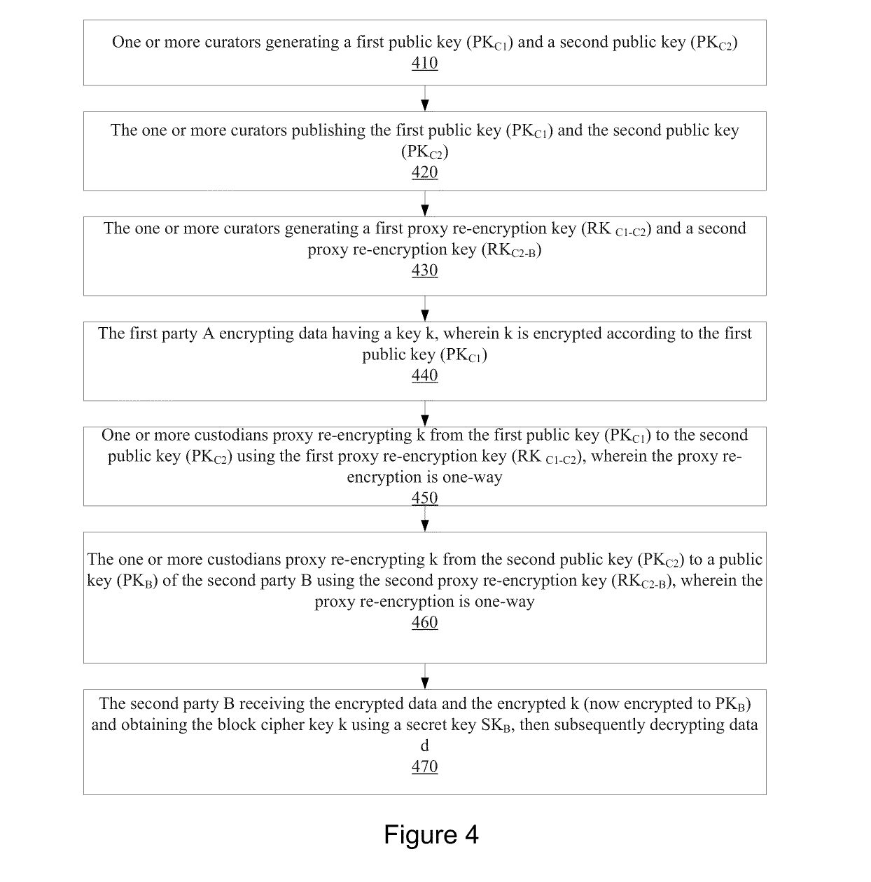

FIG. 4 is a flow chart that includes steps of a method of providing trustworthy workflow across trust boundaries between a first party A and a second party B. A first step 410 includes one or more curators generating a first public key (PK_{C1-C2}) and a second public key (PK_{C2}). A second step 420 includes the one or more curators publishing the first public key (PK_{C1}) and the second public key (PK_{C2}). A third step 430 includes the one or more curators generating a first proxy re-encryption key (RK _{C1-C2}) and a second proxy re-encryption key (RK_{C2-B}). A fourth step 440 includes the first party A encrypting data having a key k, wherein k is encrypted according to the first public key (PK_{C1}). A fifth step 450 includes one or more custodians proxy re-encrypting k from the first public key (PK_{C1}) to the second public key (Pk_{C2}) using the first proxy re-encryption key (RK_{C1-C2}), wherein the proxy re-encryption is one-way. A sixth step 460 includes the one or more custodians proxy re-encrypting k from the second public key (PK_{C2-B}) to a public key (PK_{B}) of the second party B using the second proxy re-encryption key (RK_{C2-B}), wherein the proxy re-encryption is one-way. A seventh step 470 includes the second party B receiving the encrypted data and the encrypted k (now encrypted to PK_{B}) and obtaining the block cipher key k using a secret key SK_{B}, then subsequently decrypting data d.

As described, the method of providing trustworthy workflow across trust boundaries between a first party A and a second party B, includes multiple hops. That is, a first hop is provided by the one or more custodians proxy re-encrypting k from the first public key (PK_{C1}) to the second public key (PK_{C2}) using the first proxy re-encryption key (RK_{C1-C2}), and a second hop is provided by the one or more custodians proxy re-encrypting k from the second public key (PK_{C2}) to a public key (PK_{B}) of the second party B using the second proxy re-encryption key (RK_{C2-B}). Other embodiments can include more than two hops. For at least some embodiments, the proxy re-encryption being one-way includes the one or more curators generating the proxy re-encryption key utilizing a cryptographic one-way function. For a more specific embodiment, the cryptographic one-way function includes a cryptographic pairing, and wherein the proxy re-encryption is restricted to be one-way.

For at least some embodiments, the one or more curators includes a plurality of curators, wherein the plurality of curators act as one or more Policy Administration Points (PAP) and one or more Policy Decision Points (PDP) for one or more enterprises across trust boundaries, and further prevent the one or more custodians, acting as one or more Policy Enforcement Points (PEP), from accessing or tampering content of policies of the plurality of curators while enforcing the policies across the plurality of curators. For an embodiment, policy enforcement actions performed by one or more custodians are non-repudiable and tamper proof. For an embodiment, the plurality of curators translate the policies into the generation of the first public key (PK_{C1}), the second public key (PK_{C2}), the first secret key (SK_{C1}), the second secret key (SK_{C2}). For an embodiment, for each policy there are multiple public keys PKs and secret keys SKs, but every policy does not need to have a proxy re-encryption key RK. For an embodiment, publishing the first public key (PK_{C1}) and the second public key (PK_{C2}) includes the plurality of curators sending the first public key (PK_{C1}) and the second public key (PK_{C2}) to the one or more custodians. An embodiment further includes the plurality of curators requesting for policy enforcement, including publishing the first proxy re-encryption key (RK_{c1-c2}) and the second proxy re-encryption key (RK_{c2-B}) to the one or more custodians, and sending requests to perform one or more proxy re-encryption operations to the one or more custodians. An embodiment further includes the one or more custodians enforcing the policies by performing the proxy re-encrypting of k from the first public key (PK_{C1}) to the second public key (PK_{C2}) and proxy re-encrypting k from the second public key (PK_{C2}) to a public key (PK_{B}),

For an embodiment, the one or more curators include a single curator. For another embodiment, the one or more curators include a plurality of curators

For an embodiment, the one or more custodians include a single custodian. For another embodiment, the one or more custodian comprises a plurality of custodian, and wherein a custodian can be instantiated by one public or private cloud provider. With multiple custodians, each custodian can be an organization or an individual that can enjoy a higher level of availability, performance, flexibility and mobility of a cloud network as well as price arbitrage.

For an embodiment, the one or more curators generate the second proxy re-encryption key (RK_{C2-B}) without knowledge of the secret key SK_{B}. Further, for an embodiment, this includes the one or more curators obtaining a public key of the second party B, and generating the second proxy re-encryption key (RK_{C2-B}) by applying a cryptographic function to the public key of the second party B.

For an embodiment, the one or more curators maintain a first secret key (SK_{C1}) and a second secret key (SK_{C2}). As described, for one embodiment a single curator maintains the first secret key and the second secret key (SK_{C2}). For another embodiment, a first curator maintains the first secret key and a second curator maintains the second secret key (SK_{C2}).

An embodiment further includes preventing collusion between the custodian and the second party B. Specifically, the custodian and the second party cannot collude to recover the secret key of the group owner (first party, or first party A) because the algorithm implements a one-way pairing function that makes it computationally infeasible for the custodian and the second party to work backward and recover that secret, the first party A's secret key, nor any curator's secrete key.

For at least one embodiment, the custodian includes an enterprise and the curator provides the trustworthy workflow within a cloud network. For an embodiment, Party A is a resource provider in an enterprise and the curator is an identity provider.

An embodiment further includes one or more regulators receiving logs from at least one of the first party A and the second party B. An embodiment further includes one or more curators generating a third public key (PK_{G1}) and a fourth public key (PK_{G2}), publishing the third public key (PK_{G1}) and the fourth public key (PK_{G2}), and generating a third proxy re-encryption key (RK _{G1-G2}) and a fourth proxy re-encryption key (RK_{G2-R}). Further, the first party A or the second party B encrypts log data having a key k1, wherein k1 is encrypted according to the third public key (PK_{G1}). One or more custodians proxy re-encrypt k1 from the third public key (PK_{G1}) to the fourth public key (PK_{G2}) using the third proxy re-encryption key (RK_{G1-G2}), wherein the proxy re-encryption is one-way, and the one or more custodians proxy re-encrypt k1 from the fourth public key (PK_{C2}) to a public key (PK_{R}) of a regulator party R using the fourth proxy re-encryption key (RK_{G2-R}). Finally, the regulator party R receives the log data and decrypts with a secret key SK_{R}.

For an embodiment, the party B is the curator.

For at least some embodiments, proxy re-encryption keys are generated by the one or more curators have a time-out period in which the proxy re-encryption keys expire.

For at least some embodiments, at least one of party A and party B are within a hierarchical group, and further comprising proxy re-encrypting the k more than twice, wherein each translation of the data from one party of the hierarchical group to another party of the hierarchical group includes a proxy re-encrypting.

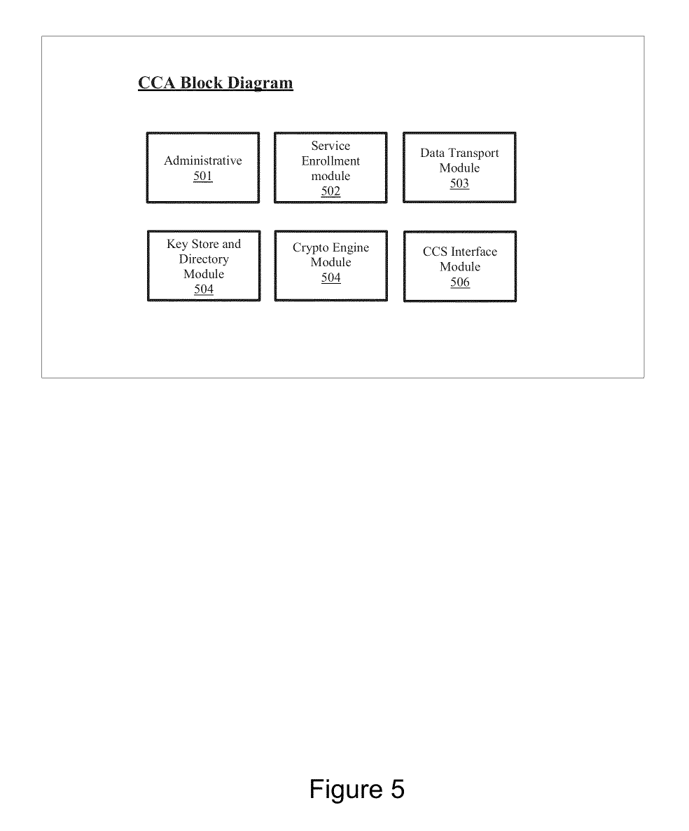

FIG. 5 shows an embodiment of the client connect agent (CCA) according to an embodiment. As previously described and shown in FIGS. 1, 2, and 3, the first party A has access to a client connect agent (CCA) 112, and the second party B has access to a client connect agent (CCA) 114. As described, an embodiment of CCA can be an independent software application program running in party A or B's computing device, such as desktop, laptop, mobile device, etc. Another embodiment of CCA is operable to run within a web browser.

As shown, this embodiment includes at least the following modules an Administrative Module 501, a Service Enrollment Module 502, a Data Transport Module 503, a Key Store and Directory Module 504, a Crypto Engine Module 505, and a CCS interface Module 506.

For an embodiment, the Administrative Module 501 performs various configuration and administrative tasks to configure the local CCA, to manage users and groups within the CCA control, to interface with human users through a command line interface (CLI) or a UI interface (UI), to interface with other programs through an application programming interface (API), to update CCA software from the connected CCS, and to send event logs to CCS via CCS Interface Module 506.

For an embodiment, the Service Enrollment Module 502 performs enrollment tasks with a realm that is represented by one or more curators. The Service Enrollment Module 502 also manages the password and the login process with the connected CCS, among others.

For an embodiment, the Data Transport Module 503 is responsible for data upload and download. The data can be uploaded from the compute device where the CCA operates and to any data repository in the cloud through any data transfer protocol such as email, HTTP, FTP, etc. or physical data storage media such as floppy disc, CD ROM, DVD ROM, USB Drive, etc., and vice versa.

For an embodiment, the Key Store and Directory Module 504 stores local user's secrets (such as the private/secret keys,) that are encrypted and copies of various certificates that can be used for local CCA cache access and offline operations.

For an embodiment, the Crypto Engine Module 505 performs various encryption/decryption, signing, and key generation functions.

For an embodiment, the CCS Interface Module 506 performs secure communications with CCS. For at least some embodiments, the CCS Interface Module 506 includes a RESTful interface Adaptera—CRUD calls for data and control communications between SCA and CCS, a WebSockets—Receive Callbacks from CCS, and a DNS Resolver—fast path for querying the CCS for directory (certificates) lookup and requesting for proxy re-encryption operations.

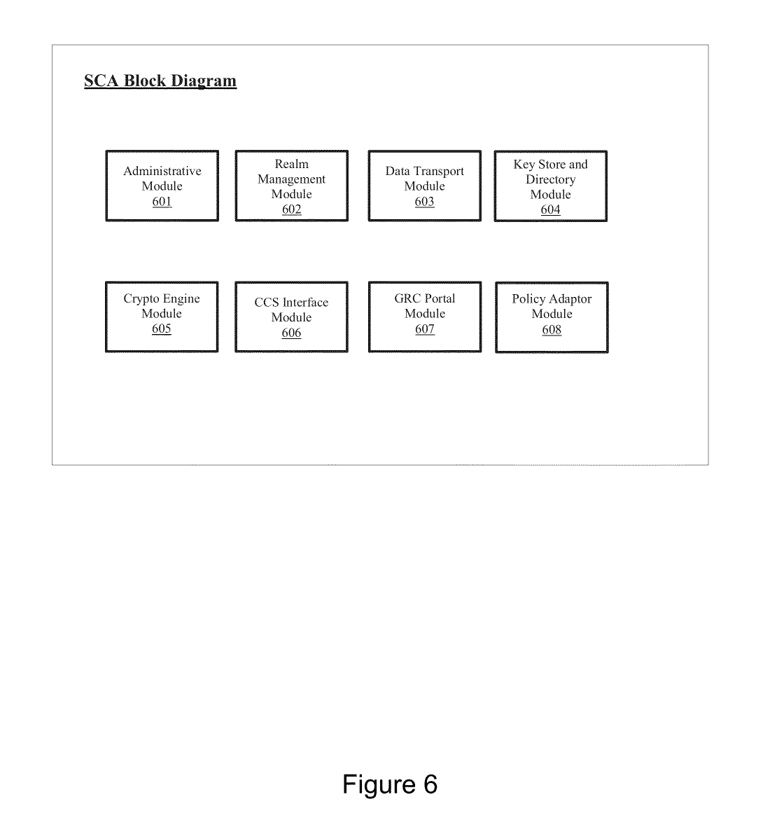

As shown, the one or more curators 140 as shown in FIGS. 1, 2 and 3 are at least partially controlled by a server connect agent (SCA) 142. For an embodiment, the SCA 142 includes a software appliance that can be packaged as, but not limited by, a piece of executable program in a binary form, a virtual machine, or a dedicated server. For at least some embodiments, the software appliance runs within a curator's firewall. Depicted in FIG. 6, the embodiments of the SCA 142 includes an Administrative Module 601, a Realm Management Module 602, a Data Transport Module 603, a Key Store and Directory Module 604, a Crypto Engine Module 605, a CCS Interface Module 606, a CRC Portal Module 607, an a Policy Adaptor Module 608.

For at least some embodiments, the Administrative Module 601 performs various configuration and administrative tasks to configure the local SCA, to manage users and groups within the SCA control, to interface with human users through a command line interface (CLI) or a UI interface (UI), to interface with other programs through an application programming interface (API), to update SCA software from the connected CCS, and to send event logs to CCS via CCS Interface Module 506.

For at least some embodiments, the Realm Management Module 602 is responsible for creating and managing a realm, the Realm Management Module 602 performs tasks to invite or permit parties that are partially controlled by CCAs to join the realm. It is also capable of revoking a realm membership. For an embodiment, a realm is one or more curators that are controlled by one SCA. Parties participating in the trustworthy workflow must be enrolled in at least one realm.

For at least some embodiments, the Data Transport Module 603 is responsible for data upload and download. The data can be uploaded from any data source within the one or more curators controlled by the SCA and to any data repository in the cloud through any data transfer protocol such as email, HTTP, FTP, etc, or physical data storage media such as floppy disc, CD ROM, DVD ROM, USB Drive, etc., and vice versa. One source of data can be content containers controlled by Microsoft© SharePoint software.

For at least some embodiments, the Key Store and Directory Module 604 stores the realm user's secrets (such as their private/secret keys,) that are encrypted and copies of various certificates that can be used for the SCA cache access and offline operations.

For at least some embodiments, the Crypto Engine Module 605 performs various encryption/decryption, signing, and key generation functions.

For at least some embodiments, the CCS Interface Module 606 performs secure communications with CCS. At least some embodiments of the CCS Interface Module 606 include a RESTful interface Adapter—CRUD calls for data and control communications between the SCA and CCS, a WebSockets—Receive Callbacks from CCS, and a DNS Resolver—fast path for querying the CCS for directory, (certificates) lookup and requesting for proxy re-encryption operations.

For at least some embodiments, the GRC Portal Module 607 is responsible for configuring logs, alerts and reports for the realm, querying, and receiving from, CCS for logs, alerts and reports, searching and indexing logs, and caching logs locally, and presenting the log information.

For at least some embodiments, the Policy Adaptor Module 608 provides integration interfaces with the existing data and identity management infrastructures in the one or more curators controlled by the SCA. For at least some embodiments, the interfaces include support for protocols and services such as, an Active Directory (AD), an Active Directory Federation Services (ADFS), a Certificate Authority (CA), a Security Assertion Markup Language (SAML), an Online Certificate Status Protocol (OCSP), and/or Proxy Services.

As shown in FIGS. 1, 2, and 3, the one or more custodians are at least partially controlled by a cloud connect service (CCS) 132. For at least some embodiments, the CCS 132 is a collection of software running as Software as a Service (SaaS) in the cloud, hosted by one or multiple Infrastructure as a Service (IaaS) providers. It is a high-scale, always-on, possibly geo-distributed policy enforcement point, which can facilitate complex, possibly cross-continental collaboration and commerce. The CCS 132 is termed “Trustworthy”, meaning that it cannot access any data or policy in the clear or cheat because it is prevented from doing so by cryptography based technologies. Without such a capability it would be technologically complex to monitor and enforce CCS 132 behavior, if at all that were to be possible.

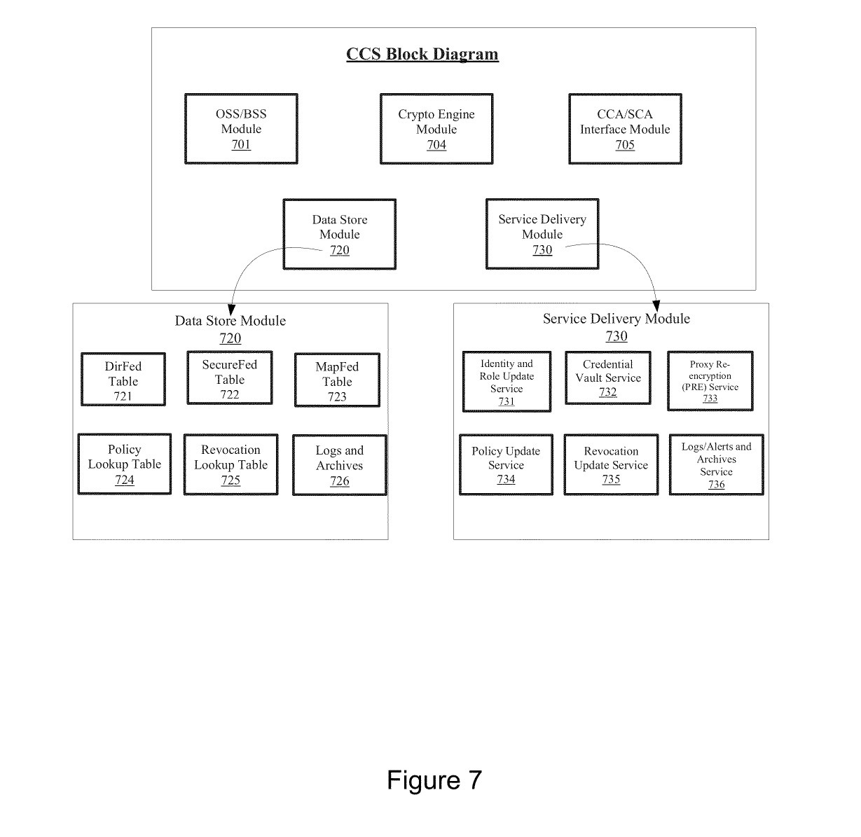

As illustrated in FIG. 7, at least some embodiments of the CCS 132 include an OSS/BSS Module 701, a Data Store Module 720, a Service Delivery Module 730, a Crypto Engine Module 704, and a CCS/SCA. Interface Module 705.

For at least some embodiments, the OSS/BSS Module 701 performs operations including provisioning, metering, billing, syndication, federations, and other external service interfaces. An embodiment of the OSS/BSS Module 701 provides customer support and trouble shooting.

For at least some embodiments, the Data Store Module 720 at least partially includes one Or more of a DirFed Table 721, SccureFed Table 722, a MapFed. Table 723, a Policy Lookup Table 724, a Revocation Lookup Table 725, and a Logs and Archives 726. For an embodiment, the DirFed Table 721 is a directory for user and group identities, certificates, policies and other artifacts, which are typically represented by the corresponding entity's public keys. For at least some embodiments, the SecureFed Table 722 stores encrypted secrets. For an embodiment, the CCS, nor any custodian, is able to decrypt any entry in this table. For at least some embodiments, the MapFed Table 723 stores, among others, Group membership records, represented, at least partially, through signed Proxy Re-encryption Keys, and Realm roles including attestations and signatures from the realm SCAs. For an embodiment, the Policy Lookup Table 724 provides rapid lookup for multi-hop re-encryption key chains. For an embodiment, the Revocation Lookup Table 725 provides rapid lookup for revocation lists. For an embodiment, the Logs and Archives 726 keeps activities logs and events. It also archives for policies and activities, as well as data.

For at least some embodiments, for each sub-module 721-726, the Service Delivery Module 730 includes at least a corresponding services delivered to CCAs and SCAs. For an embodiment, services 731-736 of the Service Delivery Module 730 may interact with multiple sub modules 721-726. For an embodiment, an Identity and Role Update Service 731 receives identity and role update requests from SCAs and CCAs and updates the corresponding DirFed 721 entries. For an embodiment, a Credential Vault Service 732 uploads and downloads the encrypted data, encrypted keys and encrypted policies upon requests from CCAs and SCAs, and updates entries in SecureFed 722 and Logs and Archives 726. For an embodiment, a Proxy Re-encryption (PRE) Service 733 receives Proxy Re-encryption Keys and Proxy Re-encryption operation requests from SCAs and CCAs, and performs the requested operations. It updates and reads entries in MapFed 723. It may also interact with Policy Lookup Table 724 and Revocation Lookup Table 725 to validate identities and authorizations. For an embodiment, a Policy Update Service 734 updates groups and group memberships in DirFed 721, upon requests from SCAs, among other tasks. For an embodiment, a Revocation Update Service 735 receives identity and rote revocation requests from, primarily, SCAs and updates entries in MapFed 723 and Revocation Lookup Table 725. Among other sources, such requests may originate from the CA and OCSP interfaces in Policy Adaptor Module 608. For an embodiment, a Logs/Alerts and Archives Service 736 receives event logs from SCAs and CCAs and responds to SCAs (GRC Portal Module 607) requests

The interaction methods between CCSs, SCAs and CCAs through above described modules and the combined system effects towards providing the trustworthy workflow across trust boundaries will become more apparent from the Operative Steps description as follows.

### Operative Steps of at Least Some Embodiments

The described embodiments provide a sequence of operative steps of how the CCA, the CCS and the SCA interact to deliver trustworthy workflows across multiple companies (curators, at least partially controlled by SCAs,), by individuals (parties, at least partially controlled by CCAs) through a cloud enabled extranet (custodian, as least partially controlled by a CCS). The exemplary trustworthy workflows of the described embodiments include secure document sharing, document classification, access policy control, user authorization, user revocation, etc., a skilled in art can construct a broad range of workflows that follow the same principles.

For an exemplary embodiment, a Company A interacts with a Company B (Auditors) and a Company C (Business Partner), through an Extranet (controlled by a common CCS), Companies A, B and C operate their own SCAs, Company A needs to selectively share documents with Company B and Company C. Individual users (Alice and Bob) use their CCAs to participate in the Extranet. Companies A. B and C have dissimilar identity, authorization and policy infrastructures. For example, Company A may leverage certificates for identity and attributes, and Company B may leverage AD, while Company C leverages SAML. Each company uses one or more interfaces of Policy Adaptor Module 608 in their SCA to integrate their Auth/AuthZ and Policy infrastructures.

For this exemplary embodiment, the parties and the roles of each of the parties can be defined as described. For this embodiment, Company A is the Resource Provider for its documents, Company A is also an Identity Provider for its own users within its own Identity system. Company A generates a Public/Secret Key Pair for each of its users. For example, user Alice has PK_{alice}/SK_{alice}. Company B is the identity Provider for its users (although it can also be a Resource Provider). Company B generates a Public/Secret Key Pair for each document classification. For example, the HBI Group has PK_{hbi}/SK_{hbi}. Company C is another Identity Provider for its users. Similarly, Company C could also be a Resource Provider in other scenarios

### One-Time Initialization of the Resource Provider

For this embodiment, Company A (Admin) configures one or more interfaces in the Policy Adaptor Module 608 to integrate with any Policy Decision Point in its existing infrastructure (such as CA). Any subsequent updates of classification or access policy, results in a callback to Policy Adaptor Module 608. Such a change results in corresponding entries (such as group, users) in DirFed Table 721, and/or other sub modules in Data Store Module 720.

### One-Time Initialization of Identity Provider

For this embodiment, Company B (Admin) configures its one or more interfaces in the Policy Adaptor Module 608 for Identity and Roles integrations with AD, ADFS, or other Identity and Authorization System. The Policy Adaptor Module 608 extracts Identities and Roles into system as User and Group key pairs, via the Crypto Engine Module 605. For each user Ui, there is a PK_{Ui}/SK_{Ui}. For each group Gi, there is a PK_{Gi}/SK_{Gi}. Any update of identities, authorizations, or expiration, or revocations will invoke Policy Adaptor Module 608 and subsequently propagates to various sub modules in Data Store Module 720 of the CCS.

Creation of a Classification

For this embodiment, Company A (Admin) configures “High Business impact.” (HBI) group to signify highly sensitive documents, using their standard mechanisms. Company A's Policy Adaptor Module 608 translates this classification group into a Public Key and a Secret Key pair by calling the GenerateKeyPair(HBI) function in Crypto Engine Module 605, and returns PK_{hbi}, and SK_{hbi}. A Function call Publish(DirFed, PK_{hbi}) in CCS interface Module 606 stores this in DirFed Table 721. This call is signed by the Company A Admin. The Crypto Engine 605 of A's SCA performs Encrypt(PK_{adminA}, SK_{hbi}) to encrypt the HBI group's secret key to the Company A Admin's public key for safekeeping. The encrypted key is now ESK_{hbi}. Publish(SecureFed, ESK_{hbi}) in CCS Interface Module 606 sends the encrypted secret key to SecureFed Table 722. This call is signed by Company A Admin

### Creation of a Role for Authorization

For this embodiment, Company B configures a group named “Auditors” using their standard group creation mechanism. This group is translated into a Public and Secret Key pair: GenerateKeyPair(Auditors) returns PK_{auditors} and SK_{auditors}. The Crypto Engine 605 does Encrypt(PK_{adminB}, SK_{auditors}) to encrypt the Auditors group's secret key to the Company B Admin's public key for safekeeping and returns ESK_{auditors}. This is signed by the Company B Admin. A Publish(SecureFed, ESK_{audtors}) securely stores the encrypted secret key in SecureFed Table 722. This is signed by the Company B Admin

Addition of Bob to the Auditors Group

For this embodiment, Company B is the Identity Provider for Bob (Bob is an employee of Company B). Company B (Admin) looks up Bob's public key in DirFed Table 721: Lookup(DirFed, Bob) call from CCS Interface Module 606 returns PK_{bob}. Check the signature of Company B's Admin, Company B retrieves the Secret Key of the Auditors group from CCS: Lookup(SecureFed, Auditors) returns the encrypted secret key (ESK_{auditors}) to the auditors group and check the signature of Company B's Admin. Then, Function Decrypt(SK_{adminB}, ESK_{auditors}) in Crypto Engine 605 returns the decrypted secret key S _{auditors} to the Company B Admin. Company B generates a proxy re-encryption key (REK) from the Auditors Public Key, to Bob's Public Key by calling RKGen(SK_{auditors}, PK_{bob}) in Crypto Engine 605. It returns REK_{auditors->bob}, which can be used by Policy Update Service 734 to do an atomic re-encryption of any document from PK_{auditors}, to PK_{bob}, Company B publishes the REK into MapFed Table 723: Publish(MapFed, REK_{auditors->bob}). This is signed with SK_{adminB} for subsequent validity checking

Classification of Documents

For this embodiment, Alice, an employee of Company A, wants to share a document that needs to be classified as HBI. Her CCA's Crypto Engine 504 does the document encryption: AES(dek, document) encrypts the document to a random document encryption key dek and gets the encrypted document Edocument. CCA (CCS Interface Module 506) retrieves the public key for the RBI group from DirFed Table 721. Alice's CCA Crypto Engine 504 then encrypts AES key to the HBI public key: Encrypt(PK_{hbi}, dek) and returns Edek. Alice's CCA then optionally publishes the document: Publish(DocFed, Edocument) optionally publishes the encrypted document to Logs and Archives 726. This is optional, since the document can be sent through any alternate data path to any data repository in the cloud. Note this is signed by Alice. Alice's CCA calls Publish(SecureFed, Edek) optionally to publish the encrypted dek to SecureFed Table 722. This is also optional, and alternatively, Edek is embedded into the header of the protected document. Note this is also signed by Alice

### Creation of an Access Control Policy

For this embodiment, Company A generates a policy that Auditors in Company B have the permission to access Company A's documents classified as HBI. Company A (admin) leverages the company's Policy Authoring Point and updates its Policy Decision Point. Company A's Policy Adapter Module 608 is notified of this policy update through a callback. Company A's SCA retrieves the public key of the Auditors group (of Company B) from DirFed Table 721: Lookup(DirFed, Auditors) returns PK_{auditors} and checks the signature of Company B's Admin. Company A's SCA retrieves the encrypted secret key of the HBI group from SecureFed Table 722 and decrypts it locally: Lookup(SecureFed, HBI) returns the encrypted secret key for the HBI group (ESK_{hbi}); Check the signature of Company A's Admin; then Decript(SL_{adminA}, ESK_{hbi}) returns the secret key for the HBI group SK_{hbi}. Company A's SCA generates a proxy re-encryption key (REK) from the HBI group's public key, to the Auditors group's public key: RKGen(SK_{hbi}, PK_{auditors}) in Crypto Engine 605 returns REK_{hbi->auditors}. Company A's SCA publishes the REK into the MapFed Table 723: Publish(MapFed, REK_{hbi->auditors}). Note that this is signed With SK_{adminA} for subsequent validity checking.

### Updates of Expiry and Revocation

For this embodiment, Company B's SCA uses the Al) Interface in Policy Adapter Module 608 to interface with Company B's AD, which enables the SCA to query, or get notifications from, AD. When there is a notification of expiry or revocation of a user, or eviction of a user from a group, the AD Interface notifies the SCA. Company B's SCA then updates any revocations into the DirtFed Table 721 through its CCS Interface Module 606: Revoke(DirFed, PKᵤₛₑᵣ) publishes a revocation of some user's public key. Revoke(MapFed, REK_{auditors->user}) publishes a revocation of that user's membership in the group. Both of these calls are signed by Company B's Admin. Upon receiving these two calls, Revocation Update Service 735 updates entries in DirFed Table 721 to remove User, updates entries in MapFed Table 723 to remove the User membership from the Auditors group, updates entries in Policy Lookup Table 724 to disconnect User from Auditors group, and updates the Revocation Lookup Table 725 to add User.

Authorized access to Documents

For this embodiment, Bob is a member of the Auditors group and Bob wants to obtain the access to the document previously encrypted and published by Alice's CCA. Bob's CCA forwards the encrypted document encryption key Edek, obtained from CCS or from the embedded part of Edocument, and his public key, to CCS through Bob's CCA's CCS Interface Module 506: Request(Edek, PK_{bob}). The Identity and Role Update Service 731 examines DirFed Table 721 to ensure that Bob is still a valid user.

The CCS attempts to find a path from the HBI group public key, to Bob's Public key: The following function calls in Policy Update Service 734 find a path through two REKs, one from HBI to Auditors, and the other from Auditors to Bob. A first function call includes Lookup(MapFed, PK_{hbi}, PK_{bob}) is the path that the CCS discovers path=(RK_{hbi->auditor}, and RK_{auditor->bob}). A second function call includes Verify(RK_{hbi->auditors}) verifies that Company A's policy fur sharing with Company B is still current, from Policy Lookup Table 724. A third function call includes Verify(RK_{auditors->bob}) verifies that Bob is still current, that Bob is a current member of the Auditors group, also from Policy Lookup Table 724.

The Proxy Re-encryption (PRE) Service 733 performs the two-hop proxy re-encryption which results in a document encryption key that is now encrypted to Bob's public key, A ProxyReEncrypt(Edek, RK_{hbi->auditors}) returns E2dek. This E2dek is now encrypted to PK_{Auditors}. A ProxyReEncrypt(E2dek, RK_{auditors->bob}) returns E3dek. This E3dek is now encrypted to PK_{bob}. The CCS logs this request from Bob and the series of operations in Logs and Archives 726 and makes it subsequently available to Company A's Admin through A's GRC Portal Module 607. The Proxy Re-encryption (PRE) Service 733 returns this re-encrypted document encryption key to Bob's CCA: Response(E3dek). Bob's CCA Crypto Engine Module 504 uses his secret key to decrypt and access the document encryption key: Decrypt(SK_{bob}, E3dek) returns the document encryption key dek in the clear. Bob's, CCA then uses the document encryption key to decrypt the document: AES(Edocument, dek) returns document in the clear.

### Revocation of User

For this embodiment, Bob leaves Company B. Company B updates its Identity system by recording this revocation, Company B's SCA is notified by this change via Policy Adapter Module 608. Company B's SCA signs and updates this information in the DirFed Table: Revoke(DirFed, PK_{Bob}). This is signed by the Company B Admin. Upon receiving this revocation, Revocation Update Service 735 will update relevant entries in Data Store Module 720 as previous described. If Bob's CCA (or anybody) attempts to obtain a proxy re-encryption, that request will be denied by the CCS. In addition, the CCS will log, and or alert, this attempted access.

Addition of an Access Control Policy

For this embodiment, Company C joins the Extranet. Company C has a group Cryptographers with a corresponding Key Pair published into DirFed Table 721 (Public Key) and SecureFed Table 722 (encrypted Secret Key). Company C notifies Company A that the Cryptographers is an official list of participants in their partnership with Company A. Company A follows the same steps as it did for Company B, and publishes a signed REK from the HBI group, to this Cryptographers group. The HBI documents can now be accessed by both the Auditors group, and the Cryptographers group. This is similar to the link created between HBI and Auditors (Company B.)

Termination of Partnership

For this embodiment, Company A terminates its business arrangement with Company B. Company As Administrator leverages its standard Policy Authoring Point. Company A's Policy Decision Point is subsequently updated. The SCA's Policy Adaptor Module 608 of Company A is notified and the SCA signs and publishes a revocation of the REK from the HBI group to the Auditors group. Any subsequent proxy re-encryption request from HBI to Auditors is denied by the CCS, and will optionally generate a log or alert as configured.

Compromise of an SCA

For this embodiment, Company C's data center is compromised, and as a result, their local SCA may have been compromised. The CCS periodically checks the certificate of the SCAs for revocation, through CRLs or OCSP responses, which can include Revoke(DirFed, PK_{adminA}) being published by a CA to indicate a revocation, via the OSS/BSS Module 701. This is signed by the CA. All subsequent updates from that SCA will be invalid until a new key pair is generated and an attested public key becomes available to the CCS. All previous updates continue to remain records of business. The CCS detects that the certificate of the SCA for Company C has been revoked. The CCS subsequently invalidates all REKs that were signed and installed by the Company C's SCA. Company C fixes its problems, subsequently obtains a new certificate, and the SCA regenerates, signs and updates a new set of REKs.

### Descriptions of Additional Embodiments

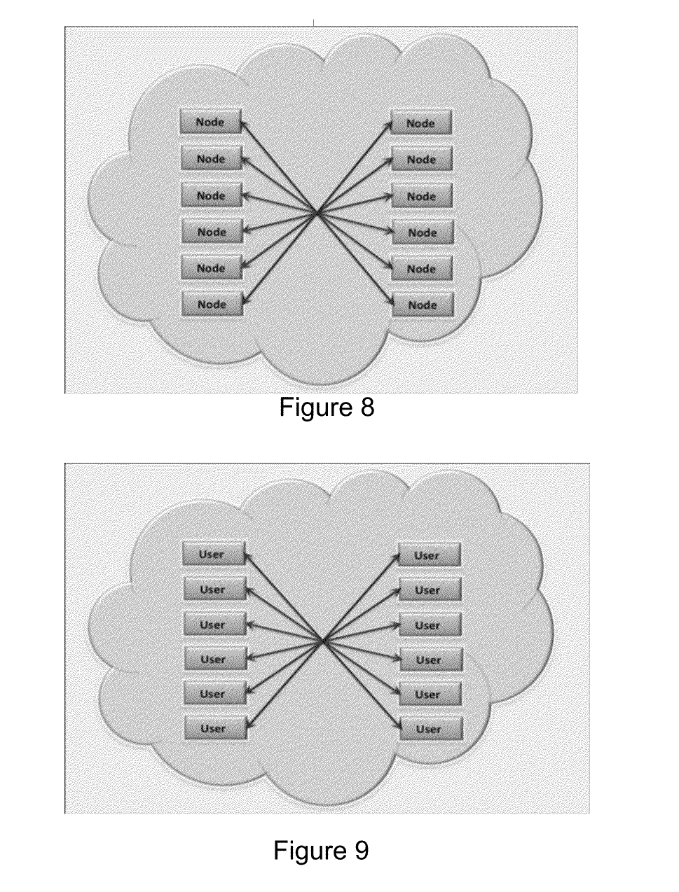

Electronic networks are composed from a variety of technologies that include e-mail, twitter®, bittorrent, extranets, and marketplaces. They are typically projects of human networks that include families, communities, educational institutions, businesses, governments, and others. Typically they implement mesh-like architectures where participants represent end points, and leveraging devices such as smartphones, tablets, laptops, browsers and other devices or services, while communicating through some form of fabric that may or may not have a service provider. See FIG. 8,

In FIG. 9, each node is an individual or a service, communicating over some medium that enables them to socialize, collaborate, conduct business, or otherwise. If there is no centralized party then this could involve client-side software that is able to discover, publish, subscribe, and perform other actions that require the network to form.

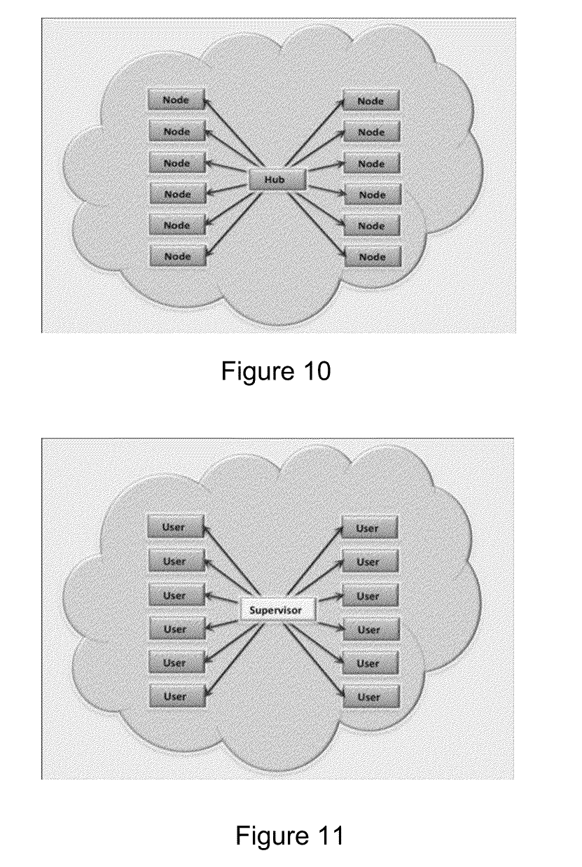

In practice there are many networks that are enabled and supported by a hosting party that is termed a “hub,” that provides some services that might include social networking (e.g., Facebook), marketplaces (e.g., e ay), extranets (e.g., Dassault Systems) and a variety of other consumer, business, government, and other services. There are a variety of standards and protocols, typically XML or JSON, and proprietary implementations that are termed “Value-add Networks” or VANs, that enable consumer, consumer-business, and business-business networks that facilitate business, entertainment, national security, and a range of other purposes. See FIG. 10.

Almost all networks tend to have rules that participants adhere to, even in pure peer-to-peer networks, where the software is designed to prevent any single participant from gaining any unfair advantage, e,g., bandwidth. More often, there is a hosting party that sets the rules, and often there are additional entities such as law enforcement and governments that monitor and supervise the networks. See FIG. 11.

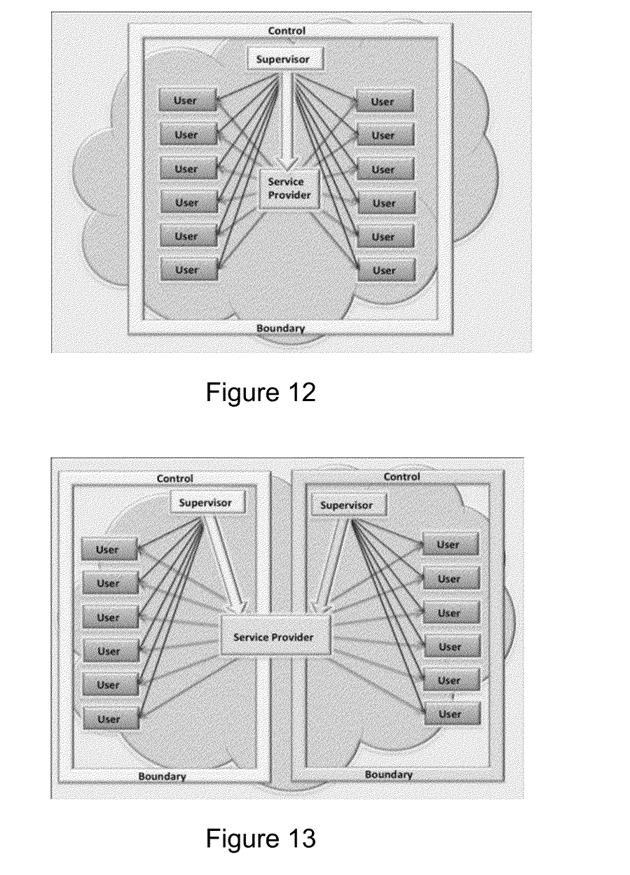

A network is in its intended level of harmony when the participants are following the rules, or the rules stated by the service providers and authorities (“supervisors”). This may not be necessarily perceived to be equitable by participants, who are being enabled through rapid technological progress to bypass the rules and supervision, or to construct their own, perhaps ad hoc networks. Therefore we see the following ostensible structure in common social, business and other networks, where there is a supervisor (typically law enforcement), a service provider that is delivering a service such as collaboration or commerce, and a variety of participants that are consuming that service, as illustrated below. See FIG. 12.

Typically within one country the law requires service providers to provide federal and other government entities with full access to data and communications in any network, for reasons that might include law enforcement or national security. This becomes a challenge for participants in a network because their privacy and security could be at risk, or their sensitive business intellectual property could be lost if there is misuse. Furthermore, many of these requests for information are accompanied by a gag order that prevents the service provider from notifying the participants about information that is provided to supervisory entities.

Electronic Networks of today operate at geo-scale, and it is often the case that these networks straddle multiple sovereign boundaries. Hence, there is frequently a situation in which a service provider is straddling multiple sovereign boundaries, and it is usually the case that the national interests of all these sovereign entities don't align, even if they are apparent allies and business partners. Therefore, given sufficient scale and geo-distribution, any service provider is likely to “hit the wall” due to conflicting legal, compliance, sovereign, and other requirements. See FIG. 13.

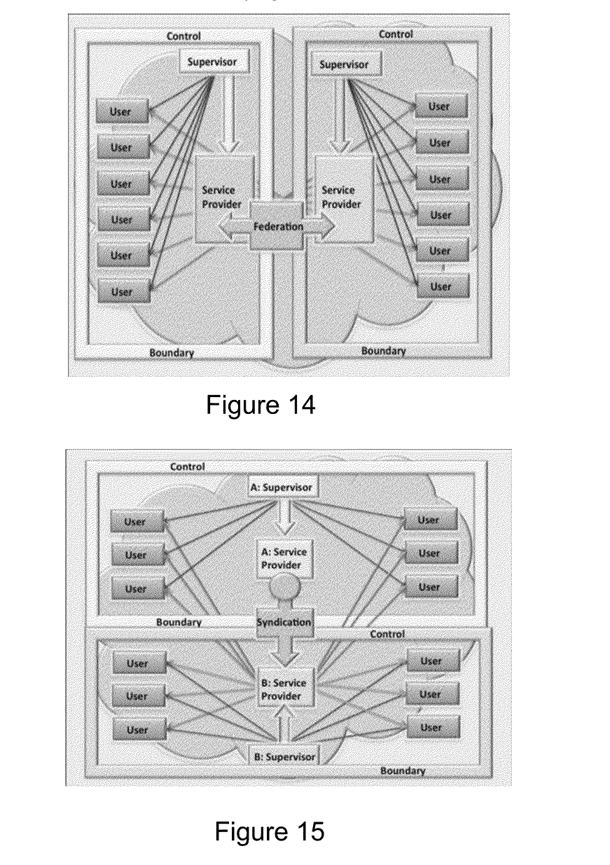

One of the consequences of this effect is that service providers could fragment along sovereign, legal or compliance boundaries, and then “federate” with other providers, as illustrated in FIG. 14.

There are additional complexities and nuances to note because in electronic networks, it is increasingly the case that service providers compose and deliver services based on other “upstream” services through mechanisms called Syndication. FIG. 8 illustrates a typical syndication scheme where a service provider “B” is re-using and enhancing or extending a service from provider “A” in some manner before delivering it to its customers. However in this example, since these service providers are in separate sovereign regions, the rules and regulations are not likely to be uniform, hence are a cause for concern among all participants, supervisors and service providers.

FIG. 15 illustrates how a service delivered to a network of participants could itself be composed by a network of service providers, which are supervised by a collection of mutually distrustful sovereign, legal and/or regulatory entities.

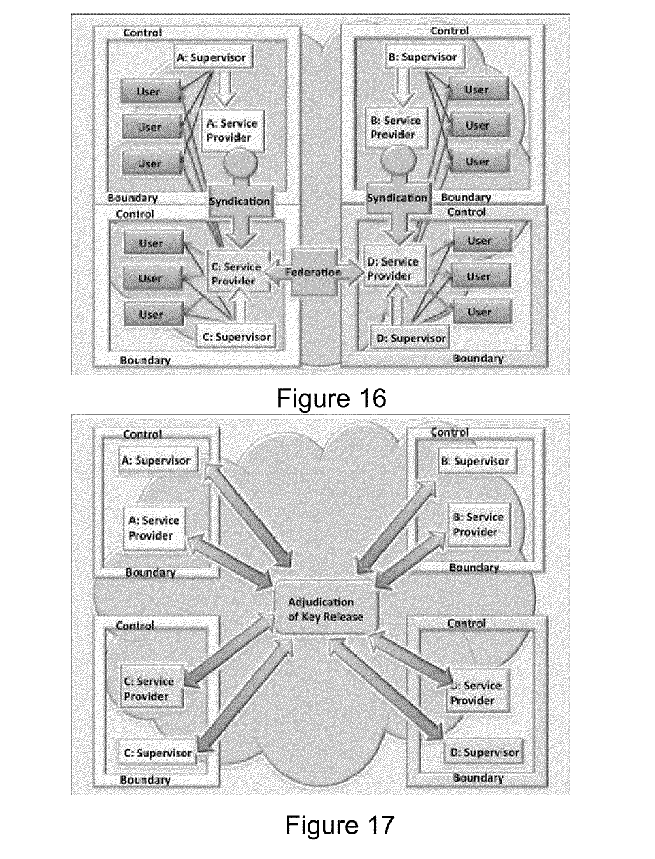

There is a growth of clouds (either hosted, or peer-to-peer) that could provide significant savings and functionality to consumers, businesses and other organizations, but these clouds also generate significant anxiety among organizations and individuals that this hidden composition of service providers and supervisors are not trustworthy. Therefore there is a growing trend to deploy cryptographic techniques so that the service providers (and hence the supervisors) are oblivious to the communications within that network, and have no access to any data that might be stored or transferred, However, the consequences of this are that the sharing of cryptographic keys tends to get complicated, and the network tends to get “dumbed down” because the service providers are limited what value they can deliver with encrypted data. In addition, keys are frequently lost, and supervisors often tend to need legitimate (or other) access to these keys for law enforcement or other purposes. Therefore the service provider is typically compelled to implement “back doors” and to provide key escrowing capabilities. However due to the geo-scale, this can become quite complex due to the conflicting requirements of this multiplicity of supervisors that are typically mutually distrusting. See FIG. 16.

In the meantime, the rise of powerful devices, 3G+ connectivity, and sophisticated collaboration software, are enabling consumers and information workers (IWs) to bypass these “silos” that are enforced by businesses, regulators and governments, in order to do their jobs in a frictionless manner. Sometimes these avenues for building ad hoc private networks, through mechanisms that include, e.g., Twitter and TOR, can have global consequences, such as the “Arab Spring”. At others, it is not completely clear if the emergence of distributed and anonymous monetary systems such as Bitcoin is a force for good, or otherwise. In this document we focus on a specific dynamic of peer-to-peer document sharing through file sharing solutions, e.g., Dropbox. However the solution that we propose for reconciling between the needs of the participants, and the supervisors, can be extended beyond documents to most other forms of information sharing, and to most other consumer, business, and other forms of networks.

Guardians

The first mechanism is an implementation in perhaps software, hardware or some equivalent or combination, of an active entity that mediates between communications across Trust boundaries (e.g., information entering or exiting a smartphone, tablet, desktop, laptop, server, private cloud, or other device, collective, or infrastructure that could demarcate a boundary of trust). FIG. 17 illustrates how two guardians can collaborate such that they implement mechanisms such as data leakage prevention on outbound data, and data provenance establishment on inbound data.

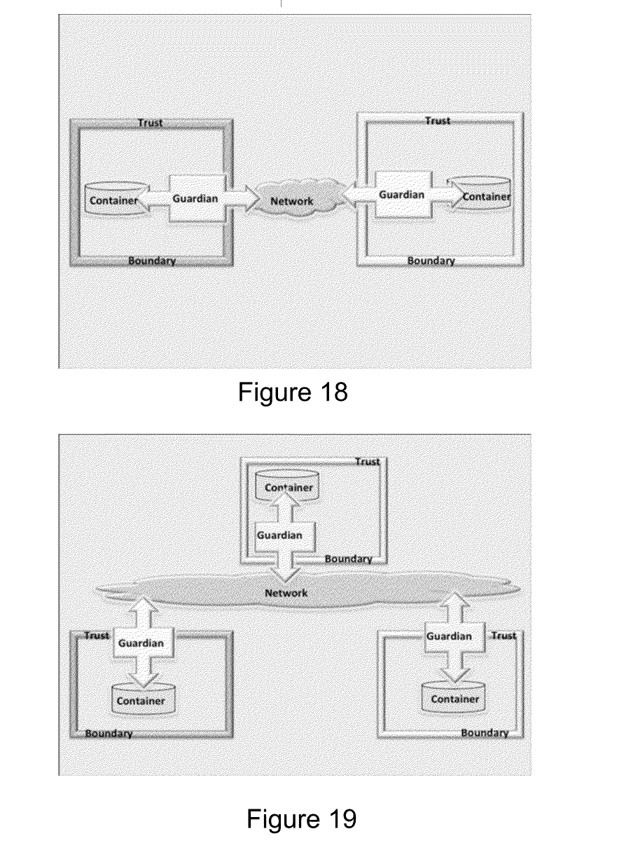

Guardians such as these can be strung together using various topologies such that they can build arbitrary topologies of participants and service providers. According to an embodiment illustrated in FIG. 18, two lower participants (or service providers) are consuming a service provided by a higher service provider.

Typically, these guardians deliver data-centric protection by encrypting the data, and then arranging for associated keys to be securely shared by participants. The data may be partially or completely protected, through encryption and signing, or other mechanisms. The cryptographic or equivalent techniques could leverage a variety of block, stream, and asymmetric techniques, and could also leverage more sophisticated schemes that might include order, format, property, and other preservation. They could also leverage searchable encryption, oblivious search, private information retrieval, full homomorphism and equivalent, in order to enable intermediaries, such as service providers that are handling the encrypted (or “protected”) data to still provide some level of value-add service, rather than be just a “blob store”.

For at least some embodiments, the described guardians are implemented as the previously described SCAs and CCAs.

Guardians are agents that can be implemented using software, hardware, or a combination. They reside on trust boundaries, such as ingress/egress points of a network connection of a laptop, desktop, server or other device. They typically perform operations on outbound data for data leakage prevention and other purposes, and on inbound data for establishing data provenance and other purposes.

Guardians might operate at “Layer 7” of a network, and could be described as “compliance firewalls”. Typically these agents leverage cryptographic techniques that include hashing_{;} signing and encryption, for implementing those capabilities. It is frequently necessary for disparate guardians to be able to communicate; hence they might establish communication channels in order to exchange data and metadata that might include cryptographic keys and policies. In any sufficiently large or geo-distributed network, it is necessary for these agents to be independent and autonomous. Hence it is desirable to minimize the need for any central entities that perform any essential orchestration for operational, trust, or other purposes.

For the greater good of science, technology, education and business, it is necessary to be able to mediate between the need for privacy, and the need for easy access to data, A Trust Network that is composed of mechanisms such as Guardians can provide the ability to aggregate or federate data and derivative metadata in a manner such that it is easily accessible to authorized participants, but also in a manner that enables the tracking of access or modifications by these authorized participants. It provides the added ability for other participants such as service providers to operate on this data in a manner that provides additional value, while preserving the data leakage prevention and provenance mechanisms.

Examples of the conflicts between privacy and accessibility of data include business, and science education, such as Clinical Trials, where there could be a conflict between the business needs of the commercial drug companies, and science and education, which could benefit from learning. In business there is a need to protect intellectual property while there is a corresponding need to enable auditability.

High-scale networks that might be cloud enabled have the ability to provide analytics and “big data” processing on this data, with the limitation that the service providers would have full access to the information. However mechanisms that can preserve the privacy and establish provenance while also providing the services with the ability to perform specific operations, through techniques that include cryptography, implemented through software, hardware or hybrid solutions.

For enabling processes such as mediation and adjudication, it is necessary to enable mechanisms such as pre-reviews and post-reviews, along with operations such as monitoring, supervision, surveillance, and arbitrary e-discovery workflows. In addition since these could be business records, it is necessary to federate lifecycle management across trust boundaries, which might include lifecycle operations such as retention, secure disposition, and retention hold. For reasons of privacy or efficiency, it is highly desirable to be able to implement these operations at fine grain, where portions of a document could be protected, for scenarios where the data is in the form of documents.

Although specific embodiments have been described and illustrated, the embodiments are not to be limited to the specific forms or arrangements of parts so described and illustrated.

What is claimed:

1. A method of providing trustworthy workflow across trust boundaries between a first party A and a second party B, comprising:
one or more curators generating a first public key (PK_{C1}) and a second public key (PK_{C}), and the one or more curators generating and maintaining a first secret key (SK_{C1}) and a second secret key (SK_{C});
the one or more curators publishing the first public key (PK_{C1}) and the second public key (PK_{C2});
the one or more curators generating a first proxy re-encryption key RK_{C1-C2}) and a second proxy re-encryption key (RK_{C2-B});
the first party A encrypting data having a key k, wherein k is encrypted according to the first public key (PK_{C1});
one or more custodians proxy re-encrypting k from the first public key (PK_{C}) to the second public key (PK_{C2}) using the first proxy re-enctyption key (RK_{C1-C2}) herein the proxy re-encryption is one-way;
the one or more custodians proxy re-encrypting k from the second public key (PK_{C2}) to a public key (PK_{B}) of the second party B using the second proxy re-encryption key (RK_{C2}), wherein the proxy re-encryption is one-way; and
the second party B receiving the data and decrypting the data with the key k, decrypted from a secret key SK_{B},

2. The method of claim 1, wherein the proxy re-encryption being one-way comprises:
the one or more curators generating the proxy re-encryption key utilizing a cryptographic one-way function., wherein the cryptographic one-way function comprises a cryptographic pairing, and wherein the proxy re-encryption is restricted to be one-way.

3. The method of claim 1, wherein the one or more curators generate the second proxy re-encryption key (RK_{C2-B}) without knowledge of the secret key SK_{B} comprising:
obtaining a public key of the second party B;
generating the second proxy re-encryption key (RK_{C2-B}) by applying a cryptographic function to the public key of the second party B.

4. The method of claim 1, further comprising preventing collusion between the one or more custodians, the one or more curators or any other party to obtain a curator secret key or any other parties' secret key, comprising utilizing a one-way pairing function.

5. The method of claim 1, further comprising preventing the ability for party B or one or more curators or one or more custodians, or in any combination to generate a proxy re-encryption that is not the intention of party A

6. The method of claim 1, wherein the one or more curators comprises a plurality of curators, acting as one or more Policy Administration Points (PAP) and one or more Policy Decision Points (PDP) for one or more enterprises across trust boundaries, and further comprising preventing the one or more custodians, acting as one or more Policy Enforcement Points (PEP), from accessing or tampering content of policies of the plurality of curators while enforcing the policies across the plurality of curators.

7. The method of claim 6, wherein policy enforcement actions performed by one or more custodians are non-repudiable and tamper proof.

8. The method of claim 6, further comprising the plurality of curators translating the policies into the generation of the first public key (PK_{C1}), the second public key (PK_{C2}), the first secret key (SK_{C1}), the second secret key (SK_{C2}).

9. The method of claim 8, wherein publishing the first public key (PK_{C1}) and the second public key (PK_{C2}) comprises the plurality of curators sending the first public key (PK_{C1}) and the second public key (PK_{C2}) to the one or more custodians.

10. The method of claim 9, further comprising the plurality of curators requesting for policy enforcement comprising publishing the first proxy re-encryption key (RK_{c1-c2}) and the second proxy re-encryption key (RK_{c2-B}) to the one or more custodians, and sending requests to perform one or more proxy re-encryption operations to the one or more custodians.

11. The method of claim 9, further comprising the one or more custodians enforcing the policies by performing the proxy re-encrypting of k from the first public key (PK_{C1}) to the second public key (PK_{C2}) and proxy re-encrypting k from the second public key (PK_{C2}) to a public key (PKₐ).

12. The method of claim 1, wherein the one or more curators, comprising an enterprise, and the one or more custodians provide the trustworthy workflow within a cloud network, wherein the one or more custodians comprise one or more cloud service providers.

13. The method of claim 12, wherein Party A is a resource provider in an enterprise and the curator is an identity provider.

14. The method of claim 1, wherein the party A or the party B is the curator.

15. The method of claim 1, wherein proxy re-encryption keys generated by the one or more curators have a time-out period in which the proxy re-encryption keys expire.

16. The method of claim 1, wherein at least one of party A and party B are within a hierarchical group, and further comprising proxy re-encrypting the k more than twice, wherein sharing of the data from one party of the hierarchical group to another party of the hierarchical group includes a proxy re-encrypting.

17. A system for providing trustworthy workflow across trust boundaries between a first party A and a second party B, comprising:
one or more curator servers operative to generate a first public key (PK_{C1}) and a second public key (PK_{C2}), wherein the One or more curators maintain a first secret key (SK_{C1}) and a second secret key (SK_{C2});
the one or more curator servers operative to publish the first public key (PK_{C1}) and the second public key (PK_{C2});
the one or more curator servers operative to generate a first proxy re-encryption key (RK_{C1-C2}) and a second proxy re-encryption key (RK_{C2-B});
the first party server A operative to encrypt data having a key k, wherein k is encrypted according to the first public key (PK_{C1});
one or more custodian servers operative to proxy re-encrypt k from the first public key (PK_{C1}) to the second public key (PK_{C2}) using the first proxy re-encryption key (RK_{C1-C2}) wherein the proxy re-encryption is one-way;
the one or more custodians servers operative to proxy re-encrypt k from the second public key (PK_{C2}) to a public key (RK_{C2-B}) of the second party using the second proxy re-encryption key (RK_{C2-B}), wherein the proxy re-encryption is one-way; and
the second party server B operative to receive the data and decrypting the data with the key k, decrypted from a secret key SK_{B}.

18. The system of claim 17, wherein the one or more curators servers comprises a plurality of curator servers, and the plurality curator servers are operative to acti as one or more Policy Administration Points (PAP) and one or more Policy Decision Points (PDP) for one or more enterprises across trust boundaries, and are further operative to prevent the one or more custodian servers, acting as one or more Policy Enforcement Points (PEP), from accessing or tampering content of policies of the plurality of curator servers while enforcing the policies across the plurality of curator servers.

19. A method of enabling one or more custodians to provide trustworthy workflow across trust boundaries between a first party A and a second party B, comprising:
receiving, by the one or more custodians, a first public key (PK_{C1}) and a second public key (PK_{C2});
receiving, by the one or more custodians, a first proxy re-encryption key (RK_{C1-C2}) and a second proxy re-encryption key (RK_{C2-B});
receiving, by the one or more custodians, encrypted data having a key k, wherein k is encrypted according to the first public key (PK_{C1});
proxy re-encrypting k from the first public key (PK_{C1}) to the second public key (PK_{C2}) using the first proxy re-encryption key (RK_{C1-C2}), wherein the proxy re-encryption is one-way;
proxy re-encrypting k from the second public key (PK_{C2}) to a public key (PK_{B}) of the second party B using the second proxy re-encryption key (RK_{C2-B}), wherein the proxy re-encryption is one-way; and
sending, by the one or more custodians, the encrypted data to the second party B, thereby allowing the second party B to decrypt the data with key k, decrypted from a secret key SK_{B}.

20. The method of claim 19, wherein a cloud-based cloud connect service aids the one or more custodians to proxy re-encrypt k from the first public key (PK_{C1-C2}) to the second public key (PK_{C2}) using the first proxy re-encryption key (RK_{C1-C2}), and to proxy re-encrypt k from the second public key (PK_{C2}) to a public key (PK_{B}) of the second party B using the second proxy re-encryption key (RK_{C2-B}).
